(19) United States
(12) Patent Application Publication
(10) Pub. No.: US 2004/0242747 A1
(43) Pub. Date: Dec. 2, 2004

(54) Polyoxymethylene homopolymer with improved thermal stability

(76) Inventor: Malay Nandi, Parkersburg, WV (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/448,800

(22) Filed: May 30, 2003

(51) Int. Cl. C08K 3/26

(52) U.S. Cl. 524/425

(57) ABSTRACT

A composition that comprises a polyoxymethylene that contains calcium carbonate to enable improved thermal stability of the composition. The composition has a desired TEF-T value and retains the original physical and mechanical properties of the POM that does not contain calcium carbonate.

### FIELD OF THE INVENTION

The present invention relates to a polyoxymethylene composition. More particularly, the present invention relates to a polyoxymethylene composition that has improved thermal stability as shown by air oven aging.

### BACKGROUND OF THE INVENTION

The following disclosures may be relevant to various aspects of the present invention and may be briefly summarized as follows:

U.S. Pat. No. 5,939,481 to Sugiyama et al. discloses a polyoxymethylene composition that contains hindered phenol antioxidants 0.01-3 parts, polyamides 0.001-0.3 parts and at least one metal compound, selected from among oxides and carbonates of Mg and Ca 0.001-0.5 parts, and boric acid 0.001-0.5 parts (based on polyoxymethylenes). Thus, Duracon (polyoxymethylene copolymer) 100 parts, pentaerythritol tetrakis [3-(3,5-di-tert-butyl-4-hydroxyphenyl)propionate] 0.5 parts, nylon-6 0.03 parts, MgO 0.01 parts, and H₃BO₃ 0.005 part were melt kneaded and pelletized to give a composition suitable as material for parts of electric and electronic equipment.

JP 07228751 discloses moldings obtained by extrusion molding or blow molding polyoxymethylenes 100 parts, hindered phenol antioxidants 0.01-5.0 parts, oxides and/or carbonates of Mg and/or Ca 0.001-10 parts, and polyalkylene glycol 0.01-5.0 parts. Thus, Duracon (polyoxymethylene copolymer) 100 part, triethylene glycol bis [3-(3-tert-butyl-4-hydroxy-5-methylphenyl) propionate] 0.5 parts, Mg oxide 0.01 parts, and polyethylene glycol 0.5 parts were mixed and extruded to form a test piece showing good thermal stability.

U.S. Pat. No. 4,521,488 to Hattori et al. discloses a polyoxymethylene copolymer composition containing calcium carbonate (1.25μ, 2-35 parts) and polymer (100 parts) has high heat resistance and easily roughened the surface by acids for electroplating.

JP 08231822 and JP 07062199 disclose a polyoxymethylene composition containing polymer (100 parts) antioxidant (0.01-5 parts), nitrogen compound (0.01-5 parts) or amine bases (0.01-5 parts) and/or calcium carbonate (0.001-10 parts). This composition is used to reduce the formation of formic acid equal or less to 1 microgram/cm² of the molded article surface during the heat treatment of the molded article.

U.S. Pat. No. 5,478,895 to Sugiyama et al. describes a polyoxymethylene composition (100 parts), antioxidant (0.01-5 parts), melamine-formaldehyde polycondensate (0.01-5 parts) and calcium carbonate (0.001-10 parts) used for the production of parts for electronic component.

WO 9905217 discloses 100 parts Duracon (polyoxymethylene copolymer) melt-mixed with pentaerythritol tetrakis[3-(3,5-di-tert-butyl-4-hydroxyphenyl)propionate] 0.5 parts, melamine-formaldehyde copolymer 0.3 parts, magnesium oxide 0.05 parts, and orthoboric acid 0.01 parts, pelletized and injection molded to form a test piece without scale deposition showing good heat-resistance.

JP 56028237 discloses a blend of polyoxymethylene copolymer (100 parts), calcium carbonate (2-25 parts) having excellent surface processability and high plate adhesion and thermal stability.

U.S. Pat. No. 4,831,073 to Okushiro et al. discloses a polyacetal resin composition contains 1-30% by weight of one or two or more members selected from among carbonaceous materials including carbon black, carbon fiber and graphite and 0.0005-2% by weight of one or two or more members selected from among alkali metal compounds and alkali metal compounds and alkaline earth metal compounds in properties to the total composition.

JP 20000017144 A discloses polyoxymethylene composition with improved thermal stability, that comprises polyoxymethylene (100 parts), sterically hindered phenol type antioxidant (0.01-3 parts), ionic salts of copolymers of carboxylic acids (0.0001-1 parts) and carbonates of Mg and/or Ca.

Polyoxymethylene (POM) resins decompose to generate formic acid in the presence of air at high temperature during molding. The formic acid, thus generated, further decomposes the polyoxymethylene chain. It is common to use bases or basic salts to absorb the formic acid to prevent further decomposition of a polyoxymethylene copolymer.

It is known that bases or basic salts are used for polyoxymethylene copolymer rather than polyoxymethylene homopolymer as the former is considered more tolerant chemically. The uses of bases or basic salts are likely to increase the TEF-T value of the resin and, may have a detrimental effect on the polyoxymethylene homopolymer. Prior attempts have been made to introduce: bases such as 5,5-dimethyl hydantoin, dicyanodiamide, tris(hydroxymethyl)aminomethane; and basic salt such as calcium stearate etc., into a polyoxymethylene homopolymer. The presence of such additives in a low concentration (e.g. less than 0.1%) shows an improvement in the air oven aging properties. However, the use of these additives has been restricted because they destabilize the polyoxymethylene homopolymer chain as evidenced by high TEF-T (i.e. thermally evolved formaldehyde at 259° C., see U.S. Pat. No. 5,011,890 for process details) values.

Polyoxymethylene (POM) homopolymers perform better than POM copolymers in impact strength at room temperature such as tensile strength, notched izod, flexural modulus, etc. However, the polyoxymethylene homopolymer loses its performance advantages over POM copolymers in thermal applications (i.e. temperatures above room temperature) because of poor thermal stability of the POM homopolymer. Thus, it is desirable for a polyoxymethylene homopolymer to have improved thermal stability for expanded market opportunities.

### SUMMARY OF THE INVENTION

Briefly stated, and in accordance with one aspect of the present invention, there is provided a composition comprising a polyoxymethylene material having less than 0.4 weight percent calcium carbonate, wherein said polyoxymethylene is a homopolymer.

Pursuant to another aspect of the present invention, there is provided a composition for improved thermal stability comprising a polyoxymethylene homopolymer and less than 0.4 weight percent calcium carbonate.

Pursuant to another aspect of the present invention, there is provided a composition comprising a polyoxymethylene material comprising TEF-T values of less than or equal to 3.00.

### DETAILED DESCRIPTION OF THE INVENTION

There are expanded market opportunities for a polyacetal composition that retains its physical and mechanical properties when subjected to elevated temperatures such as that of air oven aging. An example of such a market opportunity includes but is not limited to use in the automobile industry.

In the present invention, the use of calcium carbonate as described herein in a polyoxymethylene homopolymer enables the retention of the physical and mechanical properties of polyoxymethylene in thermal applications. For example, the impact strength of the POM homopolymer is retained for a longer period of time in air oven aging as shown by the notched izod results in Table 7 without a significant affect on other physical and mechanical properties. (See Tables 1 & 3 which show that the tensile strength, elongation at break and flexural modulus remain virtually the same with the addition of calcium carbonate). Samples 1C and 2C are control samples of POM homopolymer resin do not contain calcium carbonate.

Referring to Table 7, comparison of the air oven aging of POM homopolymer samples containing calcium carbonate (i.e. 1A, 1B, 2A and 2B) to that of the control samples without calcium carbonate (i.e. 1C and 2C) show the retention of physical properties is greater for the calcium carbonate containing samples than the non calcium carbonate containing samples. The values in Table 7 at 20 days of air oven aging at 120° C., of the calcium carbonate containing POM homopolymer samples (i.e. 1A, 1 B and 2B that contain Albafil® and SuperPflex 200®, respectively) retained 82-93% of its initial impact strength relative to their impact strength at 0 days. Sample 2A, though not as high as the other calcium carbonate containing samples, showed a 62% retention in impact strength relative to it's value at 0 days, that is still above the control samples. In contrast, the control samples (i.e. 1C and 2C that do not contain calcium carbonate) retained only 45-57% of the impact strength at 20 days of air oven aging in Table 7 relative to it's value at 0 days.

Reference is now made to Table 6 which shows that the percent of weight loss is reduced in air oven aging of the POM homopolymer containing calcium carbonate. For example, after 20 days of air oven aging, the samples of 1A and 1B have values of 0.46 and 0.50 whereas the percent of weight loss for the control value is 0.53 that is greater than samples 1A and 1B. This improvement reflects the significance of the particle diameter and a surface coated with saturated or unsaturated carboxylic acids (i.e. the carbon chain length is about C4-C20) such as a stearic acid coated calcium carbonate. Other such surface coatings include metal salt (sodium, zinc etc), ester of glycerol, polyethylene glycol or ethylene oxide-propylene oxide block copolymer and/or combinations thereof.

The interparticle spacing in the polymer matrix may be important to retain the polyoxymethylene homopolymer properties in air oven aging. Lower or higher interparticle spacing in the polymer matrix would have a detrimental effect on the polyoxymethylene homopolymer. If the particle diameter is too small, the POM homopolymer may not be able to debond necessary phenomenon for the retention of properties in air oven aging. On the other hand, if the particle diameter is large, the particles may not be able to uniformly disperse in the polymer matrix, hence the resin becomes brittle. For example, the use of either the calcium carbonate SuperPflex 200® (Specialty Minerals Inc, USA, particle diameter 0.7 t with stearic acid coating) or Albafil® (Specialty Minerals Inc, USA, particle diameter 0.7μ) in polyoxymethylene homopolymer (about 45,000 number average molecular weight, Manufactured by E.I. duPont de Nemours) in 0.1% level retains the notched izod of 82-93% of its initial impact strength in comparison to 45-57% of the control polyoxymethylene homopolymer (without calcium carbonate) in 20 days air oven aging study at 120° C. (see Table 7). The percent of weight loss of polyoxymethylene homopolymer in air oven aging at 80 days (see Table 6, 1A and 1B) is also two to three times less then the original POM weight loss when SuperPflex 200® or Albafil® are present in the composition compared to the control (see Table 6, 1C) polyoxymethylene homopolymer that does not contain calcium carbonate. The particle diameter of the calcium carbonate is important in keeping the TEF-T value of the polyoxymethylene homopolymer (see Table 5, 1A and 1B that contain calcium carbonate) closer to the control polyoxymethylene homopolymer that does not contain calcium carbonate (see Table 5, 1C).

One method of obtaining the TEF-T value is as follows. The polyoxymethylene is heated for about 30 min at a temperature of 259° C. The evolved formaldehyde (i.e. the formaldehyde released by the heating) is swept by a stream of nitrogen into a titration vessel containing a sodium sulfite solution. The formaldehyde reacts with the sodium sulfite, generating sodium hydroxide. The sodium hydroxide is continuously titrated with hydrochloric acid to maintain the original pH. Then a graph, plotting time, on one axis, and the total volume of acid, on the other axis, is recorded. The volume of acid at 30 min is proportional to the formaldehyde evolved by the heated polyoxymethylene and is a quantitative measure of thermal stability (TEF-T). The volume of acid added at 10 min is used as an estimate of the raw (uncapped) polymer (TEF-R) content of the sample, and the slope and the slope of the TEF curve from 28 to 30 minutes are used to detect the presence of destabilizing impurities (TEF-D). The values for the terms in parentheses above are determined by the following equations:

TEF-T(%)=V₃₀ ×N×3.003/S

TEF-R(%)=V₁₀ ×N×3.003/S

TEF-D(%)=(V₃₀ −V₂₆)×N×3.003/S

Where V₁₀=volume of titrant at 10 min in millimeters (ml)

V₂₈=volume of titrant at 28 min in ml

V₃₀=volume of titrant at 30 min in ml

N=normality of the titrant hydrochloric acid

S=sample weight in grams (g)

3.003=(molecular weight of formaldehyde, 30.03) X (100%)/(1000 mg/g)

(TEF-T is defined along with the detailed process, in U.S. Pat. No. 5,011,890 and is incorporated herein in its entirety.)

The Albafil® and SuperPflex 200® (manufactured by Specialty Minerals Inc, USA) have the particle diameter of 0.7μ, and 0.7μ, respectively which is better than the small particle diameter of 0.07μ of UltraPflex® (manufactured by Specialty Minerals Inc, USA) and MultiPflex® (manufactured by Specialty Minerals Inc, USA).

In Table 1 it is shown that other properties such as tensile strength, elongation at break and flexural modulus remained unchanged in the presence of either Alfbafil® or SuperPflex 200®.

TABLE 1

| | 1A | 1B | 1C | 2A | 2B | 2C |
|---|---|---|---|---|---|---|
| Tensile | 10112 psi | 10012 psi | 10003 psi | 10142 psi | 10091 psi | 10119 psi |
| Modulus | | | | | | |
| Flexural | | | | | | |
| Modulus | | | | | | |
| 23° C. | 2360 MPa | 2305 MPa | 2365 MPa | 2928 MPa | 2913 MPa | 2885 MPa |
| Break | 41% | 59% | 61% | 54% | 45% | 54% |
| Elongation | | | | | | |
| at 23° C. | | | | | | |
| UnNotched | | | | | | |
| Izod | | | | | | |
| 23° C. | 267 kJ/m\hat{ }2 | 340 kJ/m\hat{ }2 | 297 kJ/m\hat{ }2 | 174 kJ/m\hat{ }2 | 186 kJ/m\hat{ }2 | 181 kJ/m\hat{ }2 |

In this present invention, it has been found that the presence of the typical particle diameter of calcium carbonate (e.g. 0.07-3.5μ) is important to the improvement of polyoxymethylene homopolymer in achieving reduced weight loss and retaining a notched izod (e.g. impact strength) for a longer period of time in air oven aging without affecting other mechanical properties (such as elongation break, tensile modulus, flexural modulus, un-notched izod, etc.) in comparison to polyoxymethylene homopolymer without the presence of calcium carbonate.

### EXAMPLES

The following examples use polyoxymethylene homopolymer (i.e. about number average molecular weight 45,000, manufactured by E.I. duPont de Nemours) as the base resin. Five different grades of precipitated calcium carbonate were combined with the polyoxymethylene homopolymer. The five grades of calcium carbonate used are described in Table 2.

TABLE 2

| | Particle | Stearic acid | |
|---|---|---|---|
| CaCO₃ | Diameter (μ) | Coating | Manufacturer |
| MultiPfleX ® | 0.07 | | Specialty Minerals Inc, |
| | | | USA |
| UltraPflex ® | 0.07 | Y | Specialty Minerals Inc., |
| | | | USA |
| SuperPflex | 0.7 | Y | Specialty Minerals Inc., |
| 200 ® | | | USA |
| Albafil ® | 0.7 | | Specialty Minerals Inc., |
| | | | USA |
| HiPflex ® | 3.5 | Y | Specialty Minerals Inc., |
| | | | USA |

As shown in Table 2, the Albafil® and MultiPflex® do not have a stearic acid coating, however, they differ in particle diameter. Small (e.g.10 lbs) blends [containing 98.5 weight percent (wt %) polyoxymethylene homopolymer having a number average molecular weight of 45,000, 0.1 wt % of a combination of two hindered phenol antioxidants, 0.46 wt % of a polyacrylamide stabilizer described in U.S. Pat. No. 5,011,890, 0.075 wt % ethylene/vinyl alcohol copolymer and 0.025 wt % N,N′-ethylene bis stearamide or N,N′-distearoyl ethylene diamine] were made with these different grades of calcium carbonate (0.1 wt %) and extruded in a 5.08 cm single screw extruder (manufactured by Killion Extruder Inc, Serial No. 10982N, melt temperature 210±5° C., screw speed 60 rpm).

The TEF-T, melt flow rate (MFR), light index (LI) and yellowness index (YI) values of the extruded cubes have been measured and appear in Table 3. In Table 3, the “control” sample does not contain calcium carbonate. The MFR was measured using the international standard method, ISO 1133. The physical appearances of polyoxymethylene homopolymer containing calcium carbonate remained comparable with the polyoxymethylene homopolymer that did not contain calcium carbonate.

TABLE 3

| | | MFR | | | |
|---|---|---|---|---|---|
| | | (g/10 min) | LI | YI | |
| CaCO₃ | Percentage | (ISO 1133) | (% of reflectance) | | TEF-T |
| Multipflex ® | 0.1 | 14.95 | 77 | 8.6 | 0.47 |
| Multipflex ® | 0.025 | 15.03 | 80.76 | 6.8 | 0.32 |
| Ultrapflex ® | 0.1 | 14.77 | 78 | 7.1 | 0.44 |
| Ultrapflex ® | 0.025 | 14.44 | 79.23 | 8.0 | 0.35 |
| Albafil ® | 0.1 | 14.93 | 78 | 8.2 | 0.27 |
| Superpflex | 0.1 | 14.76 | 79 | 7.7 | 0.33 |
| 200 ® | | | | | |
| Hipflex | 0.1 | 13.96 | 79.61 | 8.7 | 0.32 |
| Control | 0 | 15 | 80 | 6.1 | 0.27 |

Other basic salts, such as calcium stearate, increase the TEF-T value significantly when it is present at low levels. Reference is made to Table 4A which compares the control sample that does not contain calcium stearate (0%) to the TEF-T values when calcium stearate is present (0.01%-0.05%). As shown in Table 4A, the TEF-T value increases with the increase in calcium stearate. Thus, the inclusion of calcium stearate in the composition does not provide the proper TEF-T value as does the inclusion of calcium carbonate.

TABLE 4A

| calcium stearate (%) | TEF-T |
|---|---|
| 0 | 0.11 |
| 0.01 | 1.28 |
| 0.02 | 2.89 |
| 0.05 | 2.98 |

In Table 4A, the use of a base such as tris(hydroxymethyl)aminomethane, doubled the TEF-T value when added at a 0.05 wt % level. However, as shown in Table 4B, when the calcium carbonate was the SuperPflex 200(, Albafil® or HiPflex®, the TEF-T value did not significantly increase compared to the TEF-T control sample (i.e. that did not contain calcium carbonate) at 0.1 wt % level. Increasing the percentage of calcium carbonate Albafil® and Superpflex 200(to 0.4 wt % raises the TEF-T value to more than a value of 1 which is well above the control polyoxymethylene homopolymer that does not contain calcium carbonate which is the desired TEF-T value (i.e. 0.27). In the present invention, POM containing calcium carbonate that improves the air oven aging of the composition by maintaining the desired TEF-T value and the physical and mechanical properties of POM of the control (including impact strength) is formed. Reducing the percent of calcium carbonate from 0.4 weight % to 0.025 weight %, as shown in Table 4B, reduces the TEF-T value.

TABLE 4B

| | | TEF-T | | | | |
|---|---|---|---|---|---|---|
| CaCO₃ | TEF-T | (SuperPflex | TEF-T | TEF-T | TEF-T | TEF-T |
| (%) | (Albafil ®) | 200 ®) | (UltraPflex ®) | (MultiPflex ®) | HiPflex ® | (Control) |
| 0 | | | | | | 0.27 |
| 0.025 | | | 0.35 | 0.32 | | |
| 0.1 | 0.27 | 0.33 | 0.44 | 0.47 | 0.32 | |
| 0.4 | 1.21 | 2.65 | 6.6 | 5.57 | | |

Referring now to Table 5, both Albafil® and SuperPflex 200® filled compositions were then extruded in large scale (e.g. 50 lbs) to provide samples for air oven aging. The blends (containing 98.5% polyoxymethylene homopolymer of an average molecular weight of 45,000, 0.1 wt % combination of two hindered phenol antioxidants, 0.46 wt % polyacrylamide stabilizer as described in U.S. Pat. No. 5,011,890, page 13, column 15, 0.075 wt % ethylene/vinyl alcohol copolymer and 0.025 wt % N,N′-ethylene bis stearamide or N,N′-distearoyl ethylene diamine) were extruded on 5.08 cm single screw extruder (manufactured by Killion Extruder Inc, Serial No. 10982N, melt temperature 210±5° C., screw speed 60 rpm).

The extruded cubes were molded (i.e. the molding machine was manufactured by VAN DORN DEMAG Inc, serial No. 8750168, International Standard Molding Method No. ISO 294-1, 9988-2 was followed to mold bars, melt temperature 215±5° C.) to make ISO tensile and notched bars (length×width×thickness 80×10×4 mm) for air oven aging. These bars were aged in air circulating oven at 120° C. for 80 days. The bars are taken out of the oven in ten-day intervals and cooled to room temperature. Then, the following properties were measured: tensile strength, break elongation, flexural modulus, notched izod and un-notched izod. The weight loss was measured by the difference in weight of the bars before and after aging. A mean of five bar data points was considered for all of these measurements. The same experiments followed for samples 1 A and 1 B were followed for samples 2A and 2B, respectively.

Sample IDs 1A and 2A are POM homopolymer resins containing Albafil®. Sample IDs 1B and 2B are POM homopolymer resin containing SuperPflex 200®. Sample IDs 1C and 2C are control resin of POM homopolymer that do not contain calcium carbonate. Those samples containing calcium carbonate contained 0.1 weight percent in the POM homopolymer.

TABLE 5

| | | | |
|---|---|---|---|
| Sample | MFR (g/10 min) | LI | YI |

| | | | |
|---|---|---|---|
| ID | TEF-T | ISO 1133 | % of reflectance |

| | | | | |
|---|---|---|---|---|
| 1A | 0.24 | 14.68 | 84.16 | 3.25 |
| 1B | 0.24 | 14.89 | 84.02 | 2.97 |
| 1C | 0.18 | 14.9 | 84.23 | 2.26 |
| 2A | 0.3 | 12.92 | 85.82 | 3.51 |
| 2B | 0.27 | 13.81 | 85.65 | 3.21 |
| 2C | 0.2 | 13.96 | 85.09 | 2.61 |

Referring now to Table 6, the air oven aging of the polyoxymethylene homopolymer containing calcium carbonate, shows a reduction in weight loss in comparison to the control that does not contain calcium carbonate (1C). For example the percentage of weight loss for Sample 1 B at 80 days is 3.45 wt % in comparison to the 11.11 wt % of the control (1C) after 80 days of oven aging at 120° C.

TABLE 6

| | 1A | 1B | 1C |
|---|---|---|---|
| Days | % of weight loss | | |
| 10 | 0.34 | 0.50 | 0.40 |
| 20 | 0.46 | 0.50 | 0.53 |
| 30 | 0.63 | 0.59 | 0.67 |
| 40 | 1.20 | 0.93 | 2.01 |
| 50 | 2.02 | 2.32 | 5.06 |
| 60 | 2.33 | 2.38 | 4.47 |
| 70 | 4.12 | 2.34 | 5.47 |
| 80 | 4.79 | 3.45 | 11.11 |

Furthermore, the polyoxymethylene homopolymer containing either SuperPflex 200®) or Albafil® retained its notched izod impact for a longer period of time in the air oven aging study. In Table 7, 1A and 2A are POM homopolymer resin containing Albafil®; 1B and 2B are POM homopolymer resin containing SuperPflex 200®; and 1C and 2C are POM homopolymer control resin that do not contain calcium carbonate. The notched izod impact of the polyoxymethylene homopolymer containing either Albafil®) or SuperPflex 2000 retains about 82-93% of it's impact strength after 20 days of oven aging at 120° C. compared to the control polyoxymethylene homopolymer whose retained impact strength was about 45-57% (see Table 7).

TABLE 7

| | | | | | |
|---|---|---|---|---|---|
| 1A | 1B | 1C | 2A | 2B | 2C |

| | |
|---|---|
| Days | notched izod (Kj/m²) |

| | | | | | | |
|---|---|---|---|---|---|---|
| 0 | 8.4 | 9.47 | 8.46 | 8.27 | 7.51 | 8.18 |
| 10 | 7.84 | 9.53 | 7.36 | 7.81 | 8.72 | 9.27 |
| 20 | 7.81 | 7.73 | 4.8 | 5.15 | 7.02 | 3.66 |
| 30 | 6.16 | 5.35 | 3.67 | 3.36 | 3.09 | 2.77 |

The other properties of the polyoxymethylene homopolymer such as elongation at break, flexural modulus and tensile strength did not show considerable improvement over the control polyoxymethylene homopolymer (i.e. that did not contain calcium carbonate) in this experiment.

Most of the experiments were performed using polyoxymethylene homopolymer of about a number average molecular weight of 45,000. However, the present application is applicable to other polyoxymethylene homopolymers having different molecular weights with various stabilizer packages.

It is therefore, apparent that there has been provided in accordance with the present invention, polyoxymethylene homopolymer with calcium carbonate that improves thermal stability that fully satisfies the aims and advantages herein before set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A composition comprising a polyoxymethylene material having less than 0.4 weight percent calcium carbonate, wherein said polyoxymethylene is a homopolymer.

2. A composition according to claim 1, wherein said calcium carbonate comprises a particle diameter of about 0.07-3.5 microns.

3. A composition according to claim 2, wherein said calcium carbonate comprises a surface coated with saturated or unsaturated carboxylic acids, metal salt (sodium, zinc etc), ester of glycerol, polyethylene glycol or ethylene oxide-propylene oxide block copolymer and/or combinations thereof.

4. A composition for improved thermal stability comprising a polyoxymethylene homopolymer and less than 0.4 weight percent calcium carbonate.

5. A composition according to claim 4, wherein said calcium carbonate having at least one particle diameter of about 0.07-3.5 microns.

6. A composition comprising a polyoxymethylene material comprising a TEF-T values of less than or equal to 3.00.
